(19) United States
(12) Patent Application Publication
(10) Pub. No.: US 2011/0298948 A1
(43) Pub. Date: Dec. 8, 2011

(54) APPARATUS AND METHOD FOR ACQUIRING IMAGE IN PORTABLE TERMINAL

(75) Inventors: Kyoung-Keun PARK, Gyeonggi-do (KR); Dong-Sik HA, Seoul (KR)

(73) Assignee: SAMSUNG ELECTRONICS CO., LTD., Gyeonggi-Do (KR)

(21) Appl. No.: 13/111,332

(22) Filed: May 19, 2011

(30) Foreign Application Priority Data
Jun. 7, 2010 (KR) 10-2010-0053224

(51) Int. Cl. H04N 5/76

(52) U.S. Cl. 348/231.99; 348/E05.031

(57) ABSTRACT

An apparatus and method for acquiring an image in a portable terminal includes a camera processor and an application processor. The camera processor includes a camera sensor and an image storage unit storing an image acquired through the camera sensor, and is driven independently from the application processor. The application processor is driven independently from the camera processor and drives a specific application while the camera processor operates to permit simultaneous processing of an image and another function or functions of the portable terminal.

### CLAIM OF PRIORITY

This application claims priority under 35 U.S.C. §119 from a Korean patent application filed in the Korean Intellectual Property Office on Jun. 7, 2010 and assigned Serial No. 10-2010-0053224, the entire disclosure of which is hereby incorporated by reference in its entirety.

### BACKGROUND OF THE INVENTION

1. Field of the Invention

The present invention relates to an apparatus and method for acquiring an image in a portable terminal. More particularly, the present invention relates to an apparatus and method of a portable terminal to perform a camera function for image acquisition and other application functions in a portable terminal.

2. Description of the Related Art

In recent years, with the rapid development of portable terminals, the popularity and use of portable terminals have become widespread and considered a necessity of modern life in enabling a wireless voice call and information exchange.

Initially, portable terminals were recognized as a convenient and portable way to make telephone calls. However, over time as the technologies of wireless communication and the portable terminals themselves were developed, it was recognized that many other functions other than voice communication were desirable to include into portable terminals, and both service providers and a portable terminal manufacturers are competitively engaged in developing a product (or a service) that distinguishes their products and services from other enterprises.

For example, the portable terminals have evolved into multimedia equipment used to provide an electronic phone book, a game, Short Message Service (SMS), an Electronic mail (E-mail) service, a morning call and/or alarm feature, MPEG-1 Audio Layer 3 (MP3) players, a schedule management function, a digital camera, and a wireless Internet service and a wide variety of services not mentioned above.

More particularly, a digital camera function, which is one of the most popular and widely used functions by users, is becoming a basic function of the portable terminal owing to the advantage of being capable of acquiring an image without the need or bulk concerned with carrying a separate camera.

However, the digital camera function uses a great deal of resources of the portable terminal, and cannot be performed at the same time with other application function.

In a conventional portable terminal, an application processor and a camera processor for image acquisition connect with each other, and the application processor itself processes an image acquired through a camera sensor of the camera processor. This operation makes it difficult to execute other applications (e.g., a telephone call, a sound BackGround Music (BGM), a message, Web browsing and the like) during the course of performing the digital camera function, owing to a resource use of the application processor for image processing.

The result of the large resource use of the application processor for image processing is that two or more applications cannot be executed simultaneously by a portable terminal because a resource of the portable terminal is limited during image processing.

Accordingly, there is a need for an apparatus and method for controlling a resource used in an application processor of the portable terminal to make it possible to simultaneously execute a plurality of applications.

### SUMMARY OF THE INVENTION

An exemplary aspect of the present invention is to provide an apparatus and method for simultaneously executing a camera function for image acquisition and other application function in a portable terminal. Another exemplary aspect of the present invention is to provide an apparatus and method for independently constructing a camera processor for image acquisition and an application processor for application processing in a portable terminal.

A further exemplary aspect of the present invention is to provide an apparatus and method for storing an image acquired in a camera processor itself.

Yet another exemplary aspect of the present invention is to provide an apparatus and method for loading an image stored in a camera processor at the time of image acquisition, in an application processor.

In accordance with an exemplary aspect of the present invention, an image processing apparatus of a portable terminal is provided. The apparatus preferably includes a camera processor and an application processor that are capable of processing separate applications, respectively. The camera processor preferably includes a camera sensor and an image storage unit storing an image acquired through the camera sensor, and is driven independently from the application processor. The application processor is driven independently from the camera processor and drives a specific application while the camera processor operates.

In accordance with another exemplary aspect of the present invention, an image processing method of a portable terminal preferably includes defining, as a camera processor, a camera sensor and an image storage unit storing an image acquired through the camera sensor and, by driving a specific application through the an application processor while the camera processor operates, driving the camera processor and the application processor independently.

Other exemplary aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary aspects, features and advantages of the present invention will become more apparent to a person of ordinary skill in the art from the following detailed description when taken in conjunction with the accompanying drawings in which:

FIG. 1 is a block diagram illustrating an exemplary construction of a portable terminal for simultaneously performing an image acquisition function and other application function according to the present invention;

FIG. 2 is a flowchart illustrating a process of acquiring an image in a camera processor of a portable terminal according to an exemplary embodiment of the present invention;

FIG. 3 is a flowchart illustrating a process of acquiring an image in an application processor of a portable terminal according to an exemplary embodiment of the present invention;

FIG. 4 is a flowchart illustrating a process of simultaneously performing a camera function and other application function in a portable terminal according to an exemplary embodiment of the present invention;

FIG. 5A is a diagram illustrating a process of performing a camera function in a conventional portable terminal; and

FIG. 5B is a diagram illustrating a process of performing a camera function in a portable terminal according to an exemplary embodiment of the present invention.

Throughout the drawings, like reference numerals will be understood to refer to like parts, components and structures.

### DETAILED DESCRIPTION

The following description, with reference to the accompanying drawings, is provided to assist a person of ordinary skill in the art with a comprehensive understanding of certain exemplary embodiments of the invention provided herein for illustrative purposes. The description includes various specific details to assist a person of ordinary skill the art with understanding the claimed invention, but these details are to be regarded as merely exemplary. Accordingly, those of ordinary skill in the art will recognize that various changes and modifications of the illustrative examples described herein can be made without departing from the spirit of the invention and the scope of the appended claims. Further, for the purposes of clarity and simplicity, descriptions of well-known functions and constructions may be omitted as their inclusion may obscure appreciation of the subject matter of the claimed invention by a person of ordinary skill in the art.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustrative purposes only and is not to be construed as limiting the invention as defined by the appended claims and their equivalents.

It is to be understood that the singular forms “a,” “an,” and “the” include plural references unless the context clearly dictates otherwise. Thus, for example, a reference to “a component surface” includes reference to one or more of such surfaces.

By the term “substantially” it is typically meant that the recited characteristic, parameter, or value need not be achieved exactly, but that deviations or variations, including but in no way limited to, for example, tolerances, measurement error, measurement accuracy limitations and other factors known to persons of ordinary skill in the art, may occur in amounts that do not preclude the effect the characteristic was intended to provide.

Exemplary embodiments of the present invention provide an apparatus and method for simultaneously performing an image acquisition function and another application function by independently constructing an image acquiring device and an application processing device in a portable terminal according to the present invention.

Also, a portable terminal according to the present invention constructs a camera processor independently from an application processor and thereby reduces a load of the application processor. That is, unlike a conventional camera processor connecting with an application processor by a data line and a command line and storing an acquired image in the application processor, the camera processor according to the present invention includes a separate image storage unit to store its own acquired image in the image storage unit. So, the camera processor according to the present invention stores its own acquired image and, upon need, the application processor reads out the image stored in the camera processor, thereby being capable of reducing a load of the application processor. This structure results in the application processor processes other applications at the same time when the camera processor is also processing.

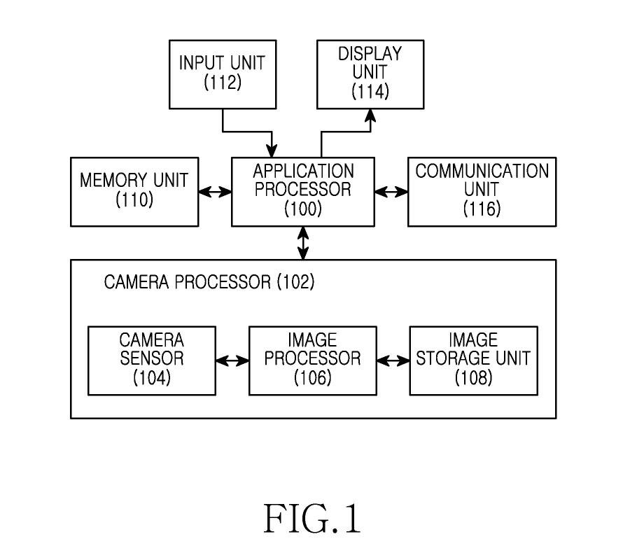

FIG. 1 is a block diagram illustrating an exemplary construction of a portable terminal for simultaneously performing an image acquisition function and at least one other application function according to the present invention.

Referring now to FIG. 1, the portable terminal may preferably include an application processor 100, a camera processor 102, a memory unit 110, an input unit 112, a display unit 114, and a communication unit 116. The camera processor 102 can include a camera sensor 104, an image processor 106, and an image storage unit 108. The portable terminal may include additional units that are not illustrated here for sake of clarity. Similarly, the functionality of two or more of the above units may be integrated into a single component, except for that of the application processor and camera processor.

The application processor 100 controls the general operation of the portable terminal. For example, the application processor 100 performs processing and control for voice call and data communication. In addition to general function, the application processor 100 processes to load and output an image stored in the camera processor 102 at image acquisition or store an acquired image in the camera processor 102 according to the present invention. Unlike a conventional application processor, the application processor 100 according to the present invention can operate independently from the camera processor 102 and save a resource use dependent on image acquisition.

The camera processor 102 operates independently from the application processor 100 according to the present invention, and processes to store an image acquired through the camera sensor 104, in its own memory, i.e., the image storage unit 108. At this time, the camera processor 102 can perform Image Signal Processing (ISP) for the acquired image and then, store the processed image.

The camera sensor 104 of the camera processor 102 preferably comprises an image sensor photographing a subject. The image processor 106 performs ISP such as AE (Auto Exposure), AWB (Auto White Balance), and AF (Auto Focus) correction and the like, for an image acquired through the camera sensor 104.

With continued reference to FIG. 1, the image storage unit 108 of the camera processor 102 comprises a memory storing an image processed by the image processor 106 and connects with the application processor 100 by the data line. The application processor 100 can load the image stored in the image storage unit 108 of the camera processor 102 through the data line for display or communication of the image either by wireless transmission, or for example, via a Universal Serial Bus (USB) port, or to permanently store the image in the memory unit, or, for example, to a micro-SD card.

The memory unit 110 includes non-transitory machine readable medium(s), such as a Read Only Memory (ROM), a Random Access Memory (RAM), a flash ROM, or other similar storage devices. The ROM stores a microcode of a program for processing and control of the application processor 100 and the camera processor 102 and a variety of reference data.

The RAM, a working memory of the application processor 100, preferably stores temporary data generated in execution of a variety of programs. The flash ROM preferably stores a diversity of updateable depository data such as a phone book, an outgoing message, and an incoming message.

The input unit 112 preferably includes numeral key buttons ‘0’ to ‘9’, a menu button, a cancel button, an OK button, a talk button, an end button, an Internet button, navigation key buttons, and a plurality of function keys such as a character input key. The input unit 112 provides key input data corresponding to a key pressed by a user to the application processor 100. A person of ordinary skill in the art understands and appreciates that in the claimed invention the keys could be virtual and the input unit and the display unit may comprise a single touch screen.

The display unit 114 displays status information generated during operation of the portable terminal, characters, moving pictures and still pictures and the like. The display unit 114 may be a color Liquid Crystal Display (LCD), an Active Mode Organic Light Emitting Diode (AMOLED) display, and other types of thin-film technology screen display apparatuses. In a case where the display unit 114 includes a touch input device and is applied to a portable terminal of a touch input scheme, the display unit 114 can be used as an input device of the portable terminal.

The communication unit 116 performs a function of transmitting/receiving and processing a wireless signal of data input/output through an antenna (not illustrated). For example, in a transmission mode, the communication unit 116 performs a function of processing original data through, for example, channel coding and spreading (such as CDMA), or other wireless protocols (TDMA, GSM, etc.), just to name a few possible wireless protocols, converting the original data into a Radio Frequency (RF) signal, and transmitting the RF signal. In a reception mode, the communication unit 116 performs a function of converting a received RF signal into a baseband signal, processing the baseband signal through de-spreading and channel decoding, and restoring the signal to original data. The communication unit 116 could also include a communication port for wired transfer, such as USB, and may also communicate in short-range protocols such as Bluetooth, etc.

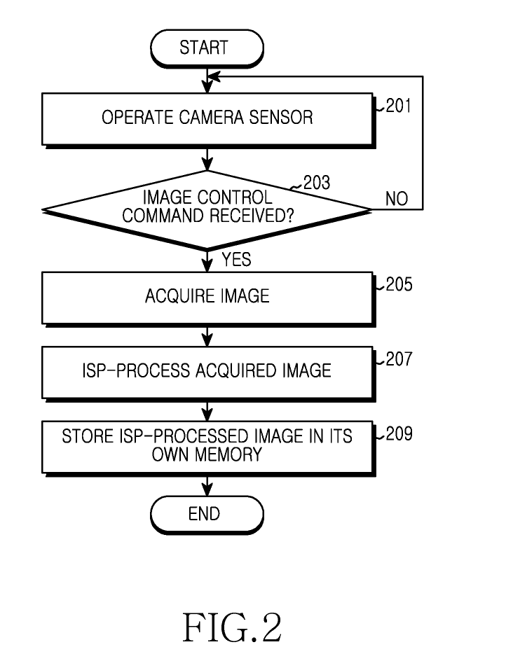

FIG. 2 is a flowchart illustrating an exemplary process of acquiring an image in a camera processor of a portable terminal according to the present invention.

Referring now to FIG. 2, the camera processor is constructed independently from an application processor and reduces the used resources of the application processor in order to permit simultaneously performance of a camera function and another application function (e.g., a call function, an MP3 play function, a game function and the like) according to the present invention as above. For example, the camera processor can include a camera sensor, an image processor that is an image signal processor for ISP, and an image storage unit storing an image acquired through the camera sensor. An example of such a possible construction is shown and FIG. 1 and has been previously discussed herein above.

First, in step 201, the camera processor (such as the camera processor 102 shown in FIG. 1) operates the camera sensor and acquires an image input through the camera sensor.

Next at step 203, the camera processor determines whether an image control command has been received from the application processor. Here, the image control command refers to a command of requesting a preview image acquired through the camera sensor and an image capturing the preview image.

If it is determined in step 203 that an image control command has not been received from the application processor, the camera processor again performs the procedure of step 201.

In contrast, when it is determined in step 203 that the image control command has been received from the application processor, the camera processor proceeds to step 205 and acquires an image corresponding to the image control command. And then, the camera processor proceeds to step 207 and performs image signal processing (ISP) for the acquired image.

With continued reference to FIG. 2, at step 209 the camera processor processes storing the ISP-processed image of step 207 in its own memory, i.e., an image storage unit (an example of which is shown in FIG. 1).

At this time, after storing the image in its own memory, or a memory other than the memory being used the application processor, the camera processor provides information informing that the image has been stored, to the application processor to allow the application processor to recognize the image storage.

The camera processor is constructed independently from the application processor according to the present invention. The camera processor can include a camera sensor, an image processor performing an ISP operation for an image acquired through the camera sensor, and a memory (i.e., an image storage unit) capable of storing the image. The camera processor stores the acquired image in the storage unit such that, upon need, the application processor loads the stored image from the camera processor.

The arrangement of the image processing being handled by another processor (the camera processor) results in a decrease of a load of the application processor in a conventional portable terminal, and decreases the used storage of a memory unit associated with the application processor as in a conventional device.

Thereafter, the portable terminal terminates the algorithm according to the present invention.

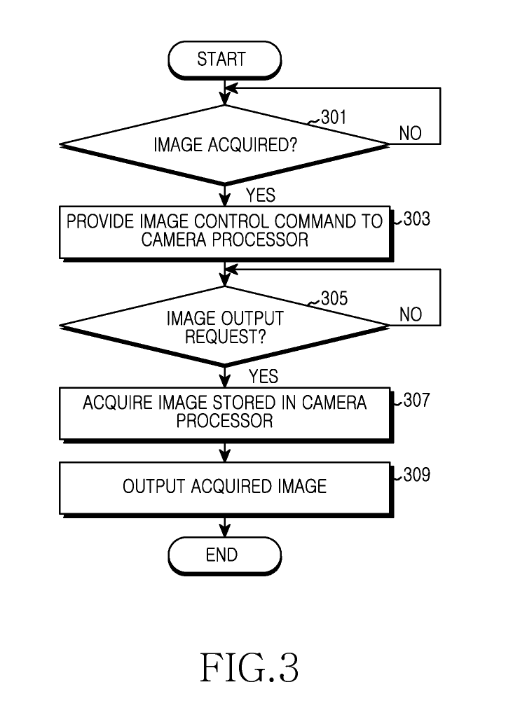

FIG. 3 is a flowchart illustrating an exemplary operational process of acquiring an image in an application processor of a portable terminal according to the present invention.

Referring now to FIG. 3, the application processor loads an image stored in an image storage unit of a camera processor instead of not receiving an image from the camera processor and storing the received image in itself as described above. Owing to this, the application processor can reduce a load resulting from itself processing an image acquired by the camera sensor.

First, in step 301, the application processor determines if a user's request for image acquisition has been detected. Here, the user's request for the image acquisition refers to a user's request requesting an image intended to be used as a preview image and an image capturing the preview image.

If the application processor determines in step 301 that the user's request for the image acquisition has not been detected, the application processor again performs the procedure of step 301. At this time, if it is circumstances that the portable terminal operates a specific application, the application processor may control the previously operating application while determining if it detects the user's request.

In contrast, if the application processor determines in step 301 that the user's request for the image acquisition has been detected, at step 303 the application processor provides an image control command to a camera processor. Next, in step 305, the application processor determines if there is an image output request from a user.

The image output request is a user's request for outputting a preview image or a capture image to a display unit. In response to the image output request, the application processor can load an image stored by the camera processor and output the loaded image to a display unit. It is also possible that the preview request may comprise a reconfigurable default.

If the application processor determines in step 305 that there is no image output request, the application processor again performs the procedure of step 305.

In contrast, if the application processor determines in step 305 that there is the image output request from the user, then at step 307 the application processor acquires an image stored in the camera processor. And then, in step 309, the application processor outputs the acquired image, for example, to a display unit, or the communication unit for transmission.

Afterward, the application processor terminates the algorithm according to the present invention.

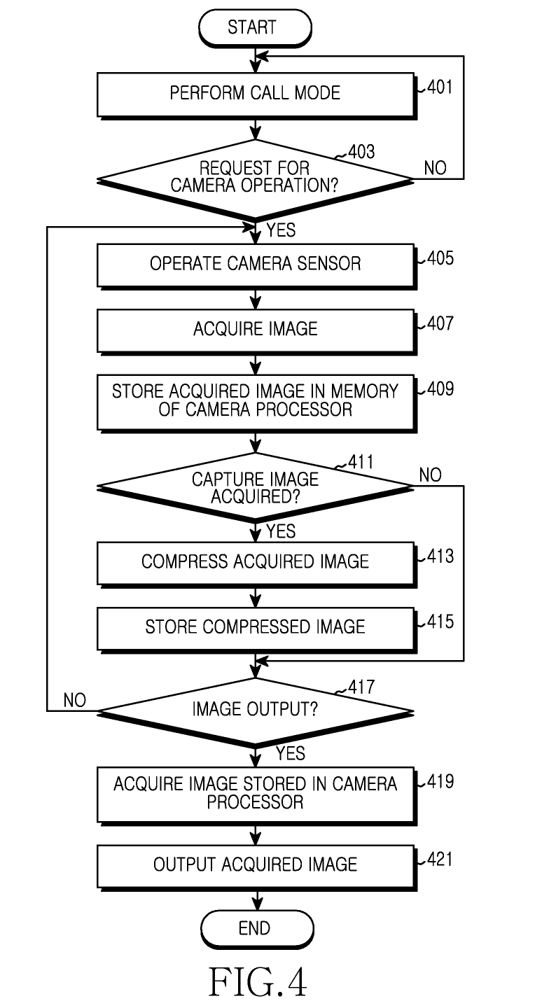

FIG. 4 is a flowchart illustrating an exemplary process of simultaneously performing a camera function and at least one other application function in a portable terminal according to a preferred exemplary embodiment of the present invention.

In FIG. 4, an exemplary processor is described for the portable terminal simultaneously performing a camera function and a call function, for example, but the present invention can simultaneously perform the camera function and an MP3 play function, or the camera function and a moving picture play function, as two possible examples.

First, in step 401, the portable terminal enters a call mode to perform a call function. And then, the portable terminal at step 403 determines if a user's request has been detected for operating a camera in the course of performing the call function.

If the portable terminal determines in step 403 that there is no detection of user's request for operating the camera concurrently with the call function, the method returns to step 401 and performs the call function.

In contrast, if the portable terminal determines in step 403 to detect the user's request for operating the camera concurrently with the call function, then at step 405 a camera processor of the portable terminal operates a camera sensor. And then, in step 407, the portable terminal acquires an image using the camera sensor.

After that, the method proceeds to step 409 where the camera processor of the portable terminal processes storage of the acquired image in an image storage unit of a camera processor unit, such as for example as shown in the arrangement of FIG. 2. The portable terminal according to the present invention processes the image acquired by the camera sensor, through the camera processor itself and not by the application processor, so as to reduce a load of the application processor.

After that, the method proceeds to step 411 where the portable terminal determines whether a capture image acquisition request from a user has been detected.

If it is determined in step 411 that the capture image acquisition request from the user has not been detected, then at step 417 the portable determines whether an image output request from the user has been detected.

In contrast, if it is determined in step 411 that there has been a detection of a capture image acquisition request from the user, then at step 413 the portable terminal compresses the acquired image into, for example, a ‘jpg’ image. And then, in step 415, the portable terminal processes storage of the compressed image in the image storage unit of the camera processor.

At this time, if the image is stored, the camera processor can provide information informing the application processor that the image has been stored, so that the application processor recognizes the image storage, and determine a time when image output is possible.

Subsequently, at step 417 the portable terminal determines whether an image output request from a user has been detected.

If it is determined in step 417 that the image output request from the user has not been detected, at step 405 the portable terminal processes the camera processor to acquire an image.

In contrast, if the portable terminal determines at step 417 to detect the image output request from the user, then at step 419 the portable terminal loads the image stored in the image storage unit of the camera processor, thereby acquiring the stored image. And then, in step 421, the portable terminal processes to output the acquired image.

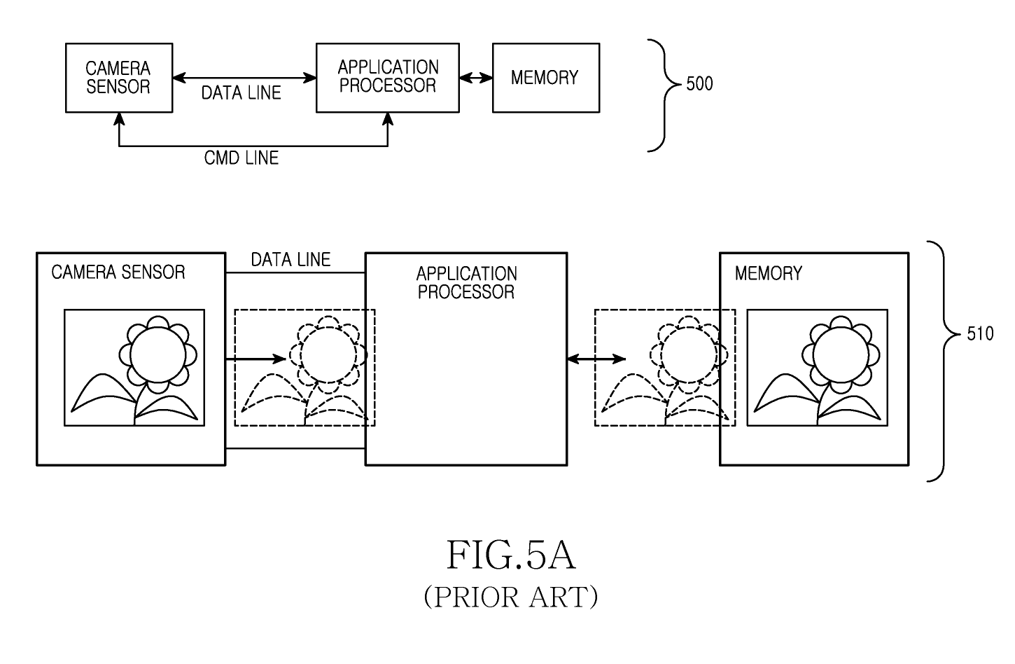

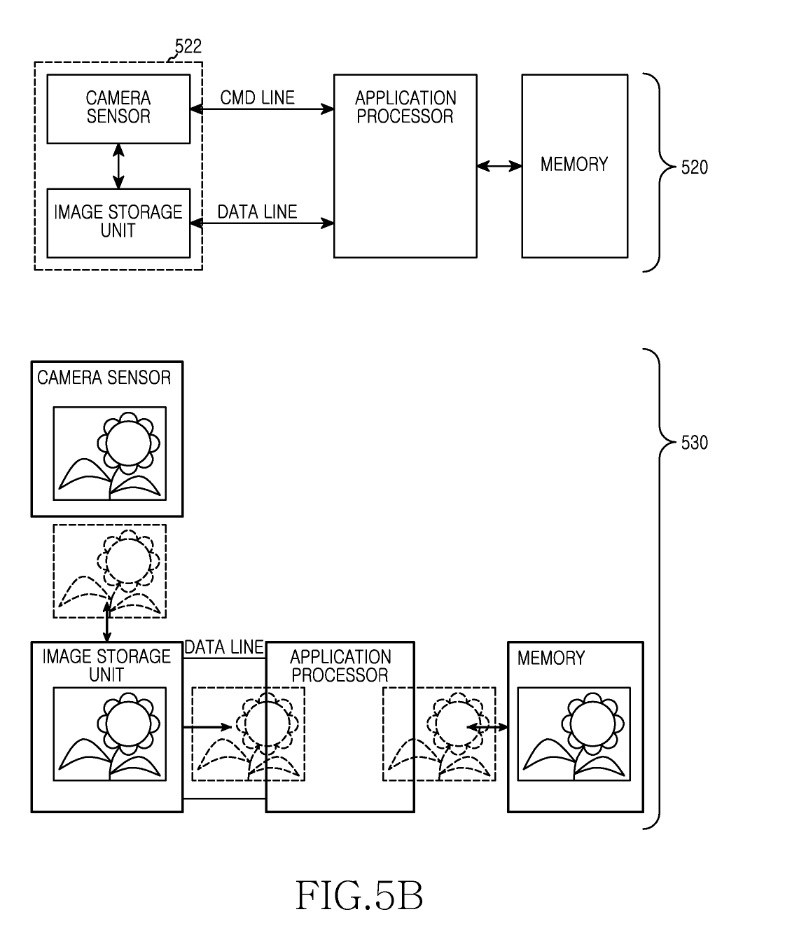

FIG. 5 is a diagram illustrating an advantage of an operational process of a portable terminal according to a preferable exemplary embodiment of the present invention versus an operational process of a conventional portable terminal.

FIG. 5A is a diagram illustrating a process of performing a camera function in a conventional portable terminal.

In FIG. 5A, the conventional portable terminal is composed of a camera sensor, an application processor, and a memory as denoted by reference numeral 500.

The camera sensor, which is a sensor acquiring an image, is connected with the application processor by a data line for transmitting the acquired image and a command (CMD) line for transmitting a command controlling the image.

In detail, in a conventional case where the application processor provides an image control command to the camera sensor through the command line, as denoted by reference numeral 510, an image acquired by the camera sensor is provided to the application processor through the data line and then, is image-processed by the application processor and then, is stored in the memory.

At this time, the application processor stores, in the memory, an image received from the camera sensor and performs an encoding/decoding procedure for the received image, and uses many resources. As a result, the application processor cannot perform another application function while performing an image acquisition procedure.

FIG. 5B is a diagram illustrating a process of performing a camera function in a portable terminal according to a preferred exemplary embodiment of the present invention.

In FIG. 5B, the portable terminal preferably includes a camera processor (522), an application processor, and a memory as denoted by reference numeral 520. The camera processor 522 can include a camera sensor, and an image storage unit 108. The camera processor (522) performs ISP such as AE (Auto Exposure), AWB (Auto White Balance), and AF (Auto Focus) correction and the like, for an image acquired through the camera sensor.

Also, the camera processor according to the present invention includes an image processor (not illustrated) performs ISP such as AE (Auto Exposure), AWB (Auto White Balance), and AF (Auto Focus) correction and the like, for an image acquired through the camera sensor.

The camera sensor is a sensor acquiring an image. Unlike a conventional structure in which a camera sensor connects with an application processor by a data line for transmitting an acquired image and a command line for transmitting a command controlling the image, the application processor is connected with the image storage unit.

In more detail, in a case where the application processor provides an image control command to the camera sensor through a command (CMD) line, an image acquired by the camera sensor is stored in the image storage unit through the data line as denoted by reference numeral 530.

The image stored in the image storage unit is an ISP-processed image (by the camera processor or the image processor), and the application processor can decrease a resource use resulting from an operation related to image processing.

Due to this arrangement, in the present invention the application processor of the portable terminal can simultaneously perform an image acquisition function using a camera and a separate application function.

For example, the camera sensor and image storage unit, which are constituent elements of the camera processor, are driven independently from the application processor, and the camera processor processes and stores an acquired image in itself or an image storage unit in communication with the camera processor.

Thereafter, in a case where the application processor intends to perform separate operation while performing image acquisition, the application processor can process to load and output an image stored in the image storage unit or store an image in the memory.

For one example, in a case where a preview image is 30 frames per second (fps) at Wide Video Graphics Array (WVGA) (800*480), a size of data per second is 800*480*2 byte*30 (≅23 Mega bytes (Mbytes)). In a case of an image storage unit of 1 Giga byte (Gbyte), the image storage unit operates at 166 Mega Hertz (MHz) and has sixteen data ports, so the image storage unit can transmit data at 332 Mbytes per second. Accordingly, even in a case of 30 fps at WVGA (800*480), the application processor can enough output an image stored in the image storage unit.

The above-described methods according to the present invention can be implemented in hardware, firmware or as software or computer code that can be stored in a recording medium such as a CD ROM, an RAM, a floppy disk, a hard disk, or a magneto-optical disk or downloaded over a network and stored on a non-transitory machine readable medium, so that the methods described herein can be rendered in such software using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

As described above, the present invention relates to an apparatus and method for simultaneously performing an image acquisition function and other application function in a portable terminal. The present invention independently constructs an image acquiring device and an application processing device to simultaneously perform the image acquisition function and other application function.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An image processing apparatus of a portable terminal, the apparatus comprising:
an application processor that drives at least one specific application of the portable terminal other than an image processing function;
a camera processor unit comprising a camera sensor, an image processor and an image storage unit storing an image acquired through the camera sensor, and driven independently from the application processor; and
wherein the application processor is driven independently from the camera processor and drives the at least one specific application while the camera processor operates to perform an image processing function.

2. The apparatus of claim 1, wherein the camera processor stores the image acquired through the camera sensor in the image storage unit, and the application processor retrieves the acquired image from the image storage unit via a data line for at least one of communication by a communication unit or display by a display unit.

3. The apparatus of claim 2, wherein the image processor of the camera processor ISP-processes the image acquired through the camera sensor, and stores the ISP-processed image in the image storage unit.

4. The apparatus of claim 1, wherein the portable terminal includes a memory in communication with application the processor for storage other an image acquired through the camera sensor.

5. The apparatus of claim 1, wherein the image storage unit is coupled with the application processor by a data line.

6. The apparatus of claim 5, wherein the camera processor unit provides a previously-stored image in the image storage unit to the application processor via the data line.

7. The apparatus of claim 6, wherein the application processor retrieves the previously-stored image from the image storage unit and outputs the previously-stored image to one of a display unit or a communication unit.

8. The apparatus of claim 1, wherein the camera processor unit performs an image operation to permit resource usage of the application processor by said at least one specific application of the portable terminal other than an image processing function.

9. The apparatus of claim 8, wherein the at least one specific application of the portable terminal other than an image processing function comprises an MP3 function.

10. The apparatus of claim 8, wherein the at least one specific application of the portable terminal other than an image processing function comprises a voice function.

11. The apparatus of claim 1, simultaneously performing an image acquisition function by the camera processor and another application function by the application processor.

12. The apparatus of claim 1, wherein the application processor loads the image stored in the image storage unit of the camera processor.

13. An image processing method of a portable terminal, the method comprising:
providing a camera processor unit, a camera sensor and an image storage unit storing an image acquired through the camera sensor; and
driving a specific application other than an image processing application through the application processor while the camera processor operates, by driving the camera processor unit and the application processor independently of each other.

14. The method of claim 13, wherein independently driving the camera processor unit and the application processor comprises:
storing in an image storage unit of the camera processor unit the image acquired through the camera sensor; and
retrieving the acquired image by the application processor loading the image stored in the image storage unit via a data line.

15. The method of claim 14, wherein allowing the camera processor unit to store, in the image storage unit, the image acquired through the camera sensor comprises:
image signal processing (ISP) by the image processor of the camera processor the image acquired through the camera sensor; and storing the ISP-processed image.

16. The method of claim 13, wherein independently driving the camera processor unit and the application processor comprises connecting the image storage unit with the application processor by a data line.

17. The method of claim 16, wherein application processor loads the image stored in the image storage unit by providing a previously-stored image to the data line connecting the image storage unit with the application processor.

18. The method of claim 13, wherein independently driving the camera processor unit and the application processor reduces resource usage of the application processor sufficient for processing of said at least one specific application of the portable terminal other than an image processing function.

19. The method of claim 13, includes simultaneously performing an image acquisition function of the camera processor and an application function of the application processor.

20. The method of claim 13, wherein independently driving the camera processor unit and the application processor comprises:
executing an application in the application processor driven independently from the camera processor unit;
when an image acquisition in required during the application execution, transmitting a control command for image acquisition to the camera processor unit; and
when notified of an existence of a stored image from the camera processor, loading the image stored in the image storage unit of the camera processor unit.
